(19) United States
(12) Patent Application Publication
(10) Pub. No.: US 2017/0369715 A1
(43) Pub. Date: Dec. 28, 2017

(54) LUMINESCENT SILICONE COATINGS

(71) Applicant: Momentive Performance Materials Inc., Waterford, NY (US)

(72) Inventors: Karthikeyan MURUGESAN, Bangalore (IN); Karthikeyan SIVASUBRAMANIAN, Bangalore (IN); Indumathi RAMAKRISHNAN, Bangalore (IN); Vivek KHARE, Bangalore (IN)

(21) Appl. No.: 15/538,220

(22) PCT Filed: Dec. 29, 2015
(86) PCT No.: PCT/US15/67872

§ 371 Date: Jun. 21, 2017

Related U.S. Application Data
(60) Provisional application No. 62/097,832, filed on Dec. 30, 2014.

(51) Int. Cl. C09D 5/22; C09D 5/00; C09K 11/06

(52) U.S. Cl. CPC C09D 5/22; C09K 11/06; C09D 5/002; C09K 2211/1029; C09K 2211/182; C09K 2211/1018

(57) ABSTRACT

The present technology provides a coating system including a luminophoric material. The luminophoric material is a pyridine-containing ligand chosen from a substituted or unsubstituted bidentate pyridine compound, a substituted or unsubstituted tridentate pyridine compound, or a combination of two or more thereof. Alternatively, the luminophoric material may be a fluorescent dye. The coating system may include a topcoat material, a primer material, or a combination thereof.

### CROSS-REFERENCE TO RELATED APPLICATIONS

The present application claims priority to and the benefit of U.S. Provisional Application No. 62/097,832 filed on Dec. 30, 2014 the disclosure of which is incorporated herein by reference in its entirety.

### FIELD

The disclosed subject matter relates to luminescent coating compositions or systems for coating a variety of substrates. In particular, the subject matter relates to a coating composition that includes a luminescent additive. The coating compositions or systems can be used as a coating, such as in a hardcoat formulation.

### BACKGROUND

Polymeric materials, particularly thermoplastics such as polycarbonate, are promising alternatives to glass for use as structural material in a variety of applications, including automotive, transportation and architectural glazing applications, where increased design freedom, weight savings, and improved safety features are in high demand. Plain polycarbonate substrates, however, are limited by their lack of abrasion, chemical, ultraviolet (UV) and weather resistance, and therefore need to be protected with optically transparent coatings that alleviate above limitations in the aforementioned applications.

Silicone hardcoats have been traditionally used to improve the abrasion resistance and UV resistance of various polymers including polycarbonate and acrylics. This enables the use of polycarbonates in a wide range of applications, including architectural glazing and automotive parts such as headlights and windshields.

Similarly, customers have an interest in hardcoat formulations with luminescent features that provide aesthetic benefits as well as enabling certain safety related applications for hardcoated polycarbonates. To meet this demand, there is a need to find the right materials for silicone hardcoat compositions which will show luminescence under UV and day light conditions without affecting the existing properties of the silicone hardcoat formulations and their final coating properties like abrasion resistance, adhesion, opticals, and weatherability as required by the specific applications.

### SUMMARY

The present technology provides a coating composition comprising a luminophoric material.

In one embodiment, the luminophoric material is a pyridine-containing ligand.

In one embodiment, the pyridine-containing ligand is chosen from a substituted or unsubstituted bidentate pyridine compound, a substituted or unsubstituted tridentate pyridine compound, or a combination of two or more thereof.

In one embodiment, the pyridine-containing ligand is a terpyridine compound of the formula:

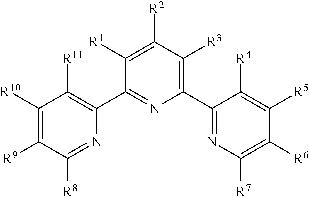

where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

In one embodiment, the terpyridine is derived from a compound of the formula:

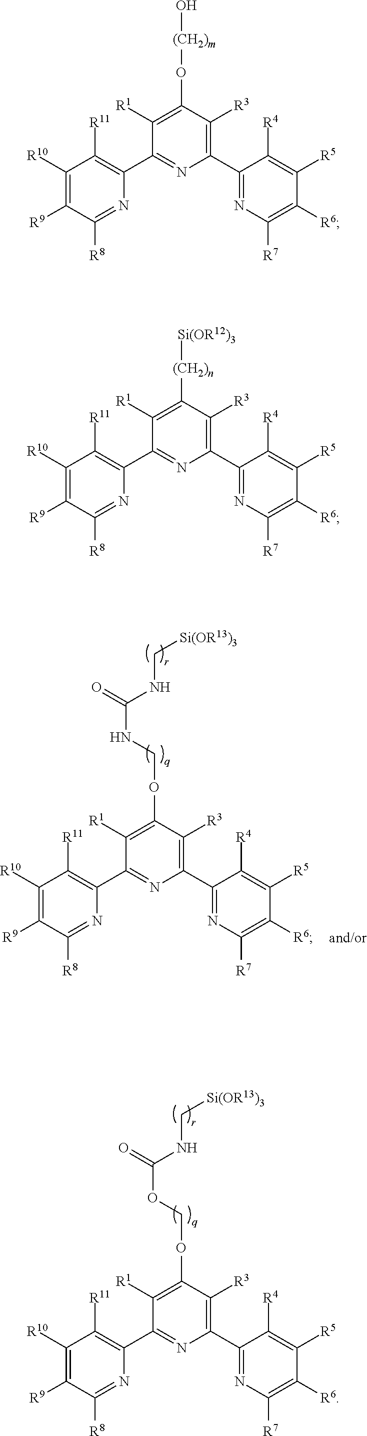

In one embodiment, the present invention provides a coating composition according to any previous embodiment, wherein the terpyridine is complexed with a metal or metal salt. In one embodiment, the metal or metal salt comprises a metal chosen from europium, erbium, cerium, neodymium, samarium, terbium, dysprosium, gadolinium, holmium, thulium, ytterbium, lutetium, or a combination of two or more thereof. In one embodiment, the metal salt comprises europium nitrate.

In one embodiment, the luminophoric material is a fluorescent dye selected from: coumarin 460 (blue), coumarin 6 (green), benzocoumarin, nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; benzoxanthene dyes; naphthalimide dyes; lactone dyes; fluorophores such as anti-stokes shift dyes; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-29-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; fluorescein and its derivatives; phenoxazines, benzophenoxazines, napthalimides; or a combination of two or more thereof.

In one aspect, the present invention provides a coating system a topcoat material, an optional primer material, or a combination thereof. In one embodiment, the topcoat material comprises the luminophoric material. In one embodiment, the primer material comprises the luminophoric material. In one embodiment, both the topcoat material and the primer material comprise the luminophoric material.

In one embodiment, the present invention provides a coating system according to any previous embodiment, wherein the luminophoric material is a pyridine-containing ligand.

In one embodiment, the present invention provides a coating system according to any previous embodiment, wherein the pyridine-containing ligand is chosen from a substituted or unsubstituted bidentate pyridine compound, a substituted or unsubstituted tridentate pyridine compound, or a combination of two or more thereof.

In one embodiment, the present invention provides a coating system according to any previous embodiment, wherein the pyridine-containing ligand is a terpyridine compound of the formula:

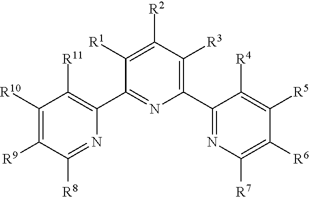

where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

In one embodiment, the present invention provides a coating system according to any previous embodiment, wherein the terpyridine is chosen from a compound of the formula:

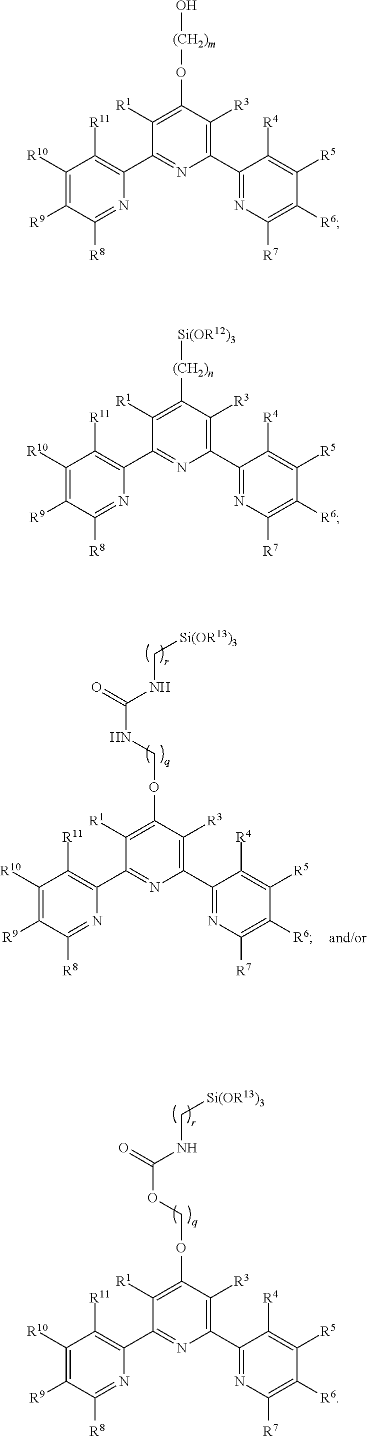

In one embodiment, the present invention provides a coating system according to any previous embodiment, wherein the terpyridine is complexed with a metal or metal salt. In one embodiment, the metal or metal salt comprises a metal chosen from europium, erbium, cerium, neodymium, samarium, terbium, dysprosium, gadolinium, holmium, thulium, ytterbium, lutetium, or a combination of two or more thereof. In one embodiment, the metal salt comprises europium nitrate.

In one embodiment, the present invention provides a coating system according to any previous embodiment, wherein the luminophoric material is a fluorescent dye selected from: coumarin 460 (blue), coumarin 6 (green), benzocoumarin, nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; benzoxanthene dyes; naphthalimide dyes; lactone dyes; fluorophores such as anti-stokes shift dyes; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-29-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; fluorescein and its derivatives; phenoxazines, benzophenoxazines, napthalimides; or a combination of two or more thereof.

In one embodiment, the coating system comprises a topcoat material, an optional primer material, or a combination thereof. In one embodiment, the topcoat material comprises the luminophoric material. In one embodiment, the primer material comprises the luminophoric material. In one embodiment, both the topcoat material and the primer material comprise the luminophoric material.

In one aspect, the present technology provides an article comprising a coating composition or coating system with the luminophoric material according to any previous embodiment, where the coating composition or coating system is disposed on at least a portion of a surface of the article.

In one embodiment, the article the surface of the article comprises a substrate chosen from an acrylic polymer, a polyamide, a polyimide, an acrylonitrile-styrene copolymer, a polyvinyl chloride, a polycarbonate, a copolycarbonate, or a combination of two or more thereof.

In one embodiment, the present invention provides a coating composition, a coating system, or an according to any previous embodiment, wherein the luminophoric material is present in an amount of from about 0.05 wt. % to about 5 wt. % based on the dry weight of a film after curing the coating.

In another aspect, the present invention provides a method for forming a coating composition or coating system according to any of the previous embodiments.

In one embodiment, the method comprises adding a metal complex to a topcoat composition, a primer material, or both, wherein the metal complex is a terpyridine compound of the formula:

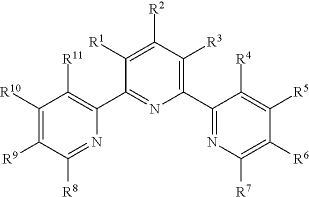

where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

In one aspect, the present technology provides a method of forming a coating composition or coating system with the luminophoric material according to any previous embodiment, where the terpyridine is chosen from a compound of the formula:

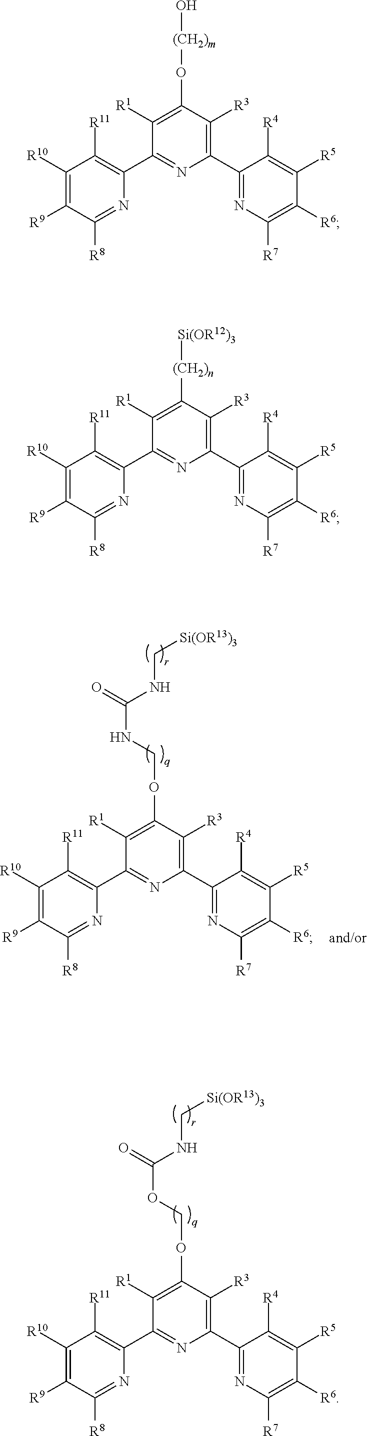

In one aspect, the present technology provides a method of forming a coating composition or coating system with the luminophoric material according to any previous embodiment, wherein the terpyridine is complexed with a metal or metal salt. In one embodiment, the metal or metal salt comprises a metal chosen from europium, erbium, cerium, neodymium, samarium, terbium, dysprosium, gadolinium, holmium, thulium, ytterbium, lutetium, or a combination of two or more thereof.

These and other aspects and embodiments of the present technology are further understood and described with reference to the following detailed description when read in connection with the accompanying drawings.

### BRIEF DESCRIPTION OF THE DRAWINGS

Included in the drawings are the following Figures:

FIG. 1 shows a graph of the UV spectra of one embodiment of the present technology; and

FIG. 2 shows a graph of the UV spectra of additional embodiments of the present technology.

### DETAILED DESCRIPTION

The present technology provides a coating composition or system that exhibits luminescent properties. The coatings can be used to coat a variety of substrates and can be used, for example, as a topcoat to provide abrasion resistance to certain surfaces. The coating compositions or systems include a luminophoric material. In one embodiment, the luminophoric material can be chosen from a pyridine-based, e.g., a terpyridine-based lanthanide complex, an organic fluorescent dye or pigment, an inorganic fluorescent dye or pigment, or a combination of two or more thereof. The coating formulations may be coated onto a substrate to provide qualities of abrasion resistance and luminescence.

As used herein, the term “alkyl” includes straight, branched, and cyclic alkyl groups. Specific and non-limiting examples of alkyls include, but are not limited to, methyl, ethyl, propyl, isobutyl, cyclohexyl, etc.

As used herein, the term “substituted alkyl” includes an alkyl group that contains one or more substituent groups that are inert under the process conditions to which the compound containing these groups is subjected. Suitable substituents can include, but are not limited to alkyl, aryl, alkenyl, alkynyl, etc. The substituent groups also do not substantially or deleteriously interfere with the process.

As used herein, the term “aryl” refers to a non-limiting group of any aromatic hydrocarbon from which one hydrogen atom has been removed. An aryl may have one or more aromatic rings, which may be fused, connected by single bonds or other groups. Examples of suitable aryls include, but are not limited to, tolyl, xylyl, phenyl, naphthalenyl, etc.

As used herein, the term “substituted aryl” refers to an aromatic group substituted as set forth in the above definition of “substituted alkyl.” Similar to an aryl, a substituted aryl may have one or more aromatic rings, which may be fused, connected by single bonds or other groups. When the substituted aryl has a heteroaromatic ring, the attachment can be through a heteroatom (such as nitrogen) of the heteroaromatic ring instead of a carbon. In one embodiment, the substituted aryl groups herein contain 1 to about 30 carbon atoms.

As used herein, the term “alkenyl” refers to any straight, branched, or cyclic alkenyl group containing one or more carbon-carbon double bonds, where the point of substitution can be either a carbon-carbon double bond or elsewhere in the group. Examples of suitable alkenyls include, but are not limited to, vinyl, propenyl, allyl, methallyl, ethylidenyl norbornyl, etc.

As used herein, the term “alkynyl” refers to any straight, branched, or cyclic alkynyl group containing one or more carbon-carbon triple bonds, where the point of substitution can be either at a carbon-carbon triple bond or elsewhere in the group.

As used herein, the term “unsaturated” refers to one or more double or triple bonds. In one embodiment, it refers to carbon-carbon double or triple bonds.

As used herein, the term “inert substituent” refers to a group other than hydrocarbyl or substituted hydrocarbyl, which is inert under the process conditions to which the compound containing the group is subjected. The inert substituents also do not substantially or deleteriously interfere with any process described herein that the compound in which they are present may take part in. Examples of inert substituents include, but are not limited to, halo (fluoro, chloro, bromo, and iodo), and ether such as —OR wherein R is hydrocarbyl or substituted hydrocarbyl.

As used herein, the term “hetero atoms” refers to any of the Group 13-17 elements except carbon, and can include, for example, oxygen, nitrogen, silicon, sulfur, phosphorus, fluorine, chlorine, bromine, and iodine.

In one aspect, the present technology provides a coating composition or system for coating an article or substrate. The coating composition may be configured to provide a relatively hard coating that may provide abrasion resistance and/or other desirable properties to the substrate. In accordance with aspects of the technology, the coating composition or system comprises a luminophoric material. The coating system comprises an outer (topcoat) layer and optional primer layer. Depending on the nature of the coating composition and the substrate to be coated, a primer layer or coating may need to be applied over the substrate to promote adhesion of the outer protective coating or topcoat layer. As used herein, the phrase “coating system” may refer to a topcoat layer alone or the combination of the primer layer and the outermost or topcoat layer.

In accordance with the present technology, the topcoat layer, the primer coating layer, or both the topcoat layer, and the primer coating layer comprises a luminophoric material. The luminophoric material may be chosen from a pyridine-containing lanthanide complex, e.g., a tepyridial-based lanthanide complex, an organic dye or pigment, an inorganic dye or pigment, or a combination of two or more thereof.

In one embodiment, the luminophoric material comprises a pyridine-containing ligand complexed with a metal that will phosphoresce upon exposure to UV radiation. The ligand may be chosen from a substituted or unsubstituted bidentate pyridine compound, a substituted or unsubstituted tridentate pyridine compound, or combinations of two or more thereof.

In one embodiment, the ligand comprises a terpyridine compound of the Formula (I):

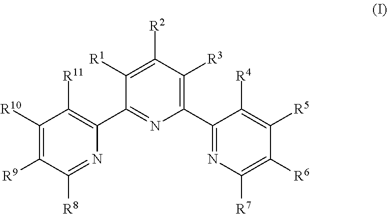

where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

In embodiments, the pyridine-containing ligand is a substituted pyridine complex comprising at least one alkoxysilyl functional group, at least one alcohol function group, or a combination of two or more thereof as an “R” substituent on the pyridine compound. In one embodiment, the remaining groups for R¹-R¹¹ may be independently chosen from hydrogen, a C1-C18 alkyl, a C1-C18 substituted alkyl, a C6-C18 aryl, and a substituted C6-C18 aryl.

The alkoxysilyl functional group and/or the alcohol functional group are employed to attach the pyridine-containing ligand to the siloxane network. In one embodiment, the alcohol functional group is chosen from a compound of the formula —O—(CH²)ₘ—OH where m is 1-20.

In one embodiment, the alkoxysilyl functional group is chosen from a functional group of the formula: —(CH²)ₙ—Si(OR¹²)₃, where R¹² is CₚH₂ₚ₊₁, p is 1-10, and n is 1-20. In another embodiment, the alkoxysilyl functional group is chosen from a functional group of the formula: —O—(CH₂)_{q}-A¹-C(O)-A²-(CH₂)ᵣ—Si(OR¹³)₃, where A¹ and A² are independently chosen from an oxygen atom or NH, q and r are independently 1-20, and R¹³ is CₚH₂ₚ₊₁ where p is 1-10. In one embodiment, A¹ and A² are each chosen from NH. In one embodiment, A¹ is O, and A² is NH. In one embodiment, A¹ and A² are each O.

The alkoxysilyl and/or alcohol functional group can be provided at any of the R¹-R¹¹ positions on the terpyridine compound. In one embodiment, the terpyridine compound comprises an alkoxysilyl or alcohol functional group at the R² position.

Examples of suitable ligands include, but are not limited to, ligands of the Formulas (II)-(V):

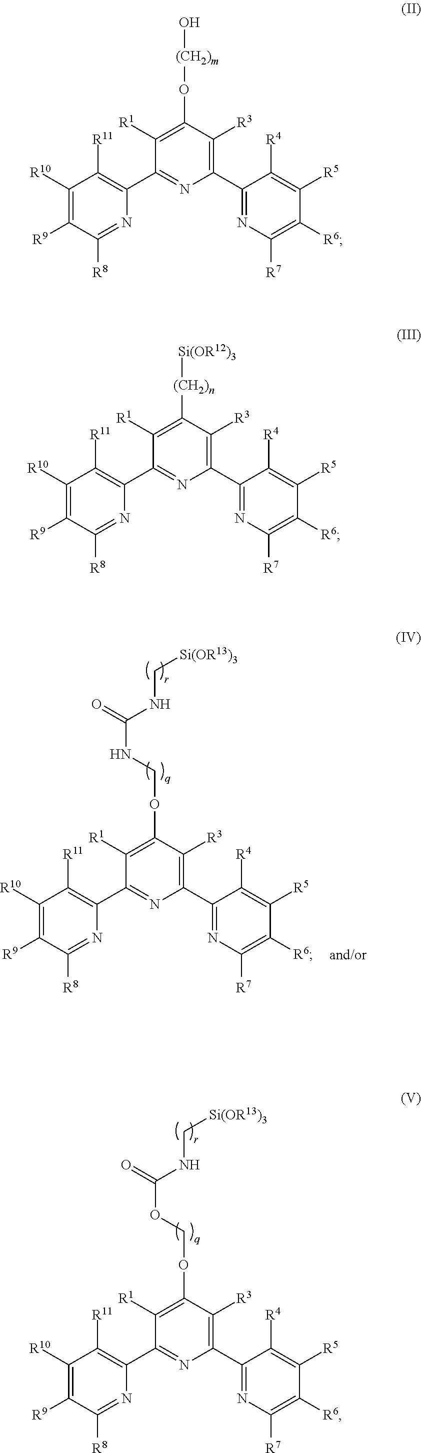

where R′ and R³-R¹³ can be as described above.

The functionalized terpyridines comprising an alkoxysilyl and/or alcohol functional group can be synthesized by any suitable method for attaching such groups to the cyclic structure of a pyridine group. In one embodiment, an alcohol functional group or an alkoxysilyl-containing functional group may be attached to a pyridine of the ligand by the condensation reaction of a diol or amino diol with a halogen substituted pyridine-containing compound (e.g., terpyridine). In one embodiment, an alkoxysilyl group can be attached to a pyridine unit by the hydrosilylation reaction between a silane hydride or siloxane hydride with an alkenyl functional pyridine-containing compound.

In embodiments, the pyridine-containing ligand may be a substituted or unsubstituted bidentate pyridine compound. Examples of suitable bidentate pyridine compounds include, but are not limited to, 2,2′ bipyridine, 3,3′ bipyridine, etc. It will be appreciated that the bidentate pyridine compound may be substituted as described with respect to the tridentate pyridine-containing ligands. That is, the groups attached to the pyridine rings may be selected from the groups described with respect to R¹-R¹¹ for the terpyridine ligands. In embodiments, the bidentate pyridine compounds may be a substituted bidentate pyridine ligand comprising an alkoxysilyl functional group, an alcohol functional group, or a combination of two or more thereof.

While the above complexes have been described with respect to pyridine-containing compounds as the ligand, it will be appreciated that one or more nitrogen atoms could be replaced with a heteroatom such as O, P or a combination thereof.

The pyridine-based ligands complex or coordinate a metal ion or metal salt. The metal may be selected as desired for a particular purpose or intended application. In one embodiment, the ligand may be complexed with a lanthanide series metal, a salt thereof, or a combination of two or more thereof. Suitable metals include, but are not limited to yttrium, lanthanum, praseodymium, promethium, europium, erbium, cerium, neodymium, samarium, terbium, dysprosium, gadolinium, holmium, thulium, ytterbium, lutetium, or combinations of two or more thereof. The metal may be provided as a metal salt or complex with a selected ion or complexing agent. The ion for forming the salt is not particularly limited and may be chosen as desired for a particular purpose or intended application. Examples of suitable ions for forming the salts include, but are not limited to, nitrates, nitrites, sulfates, sulfonates, sulfites, phosphates, phosphites, organic sulfates, organic sulfonates, halogens (chloride, fluoride, iodide), etc. In one embodiment, the salt comprises nitrates. An example of a suitable sulfonate is trfilate (trifluoromethane sulfonate). When subjected to UV irradiation, the ligand may show a characteristic phosphorescence based on the metal or metals employed. The ligand can be tuned to provide a selected color based on the concentration of the metal atoms or by complexing a plurality of metal ions or metal salts and by controlling the concentration of the respective metals complexed by the functionalized particles.

In one embodiment, the luminophoric material comprises a fluorescent dye and/or pigment. Exemplary dyes may be organic or inorganic, and may include, but are not limited to, coumarin dyes such as coumarin 460 (blue), coumarin 6 (green), benzocoumarin, nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; benzoxanthene dyes; naphthalimide dyes; lactone dyes; fluorophores such as anti-stokes shift dyes; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-29-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; fluorescein and its derivatives; phenoxazines, benzophenoxazines, napthalimides; or a combination of two or more of the foregoing dyes.

The coating composition is chosen, in one embodiment, from a material suitable for providing a topcoat. The coating composition is not particularly limited, and may be any appropriate topcoat, including, but not limited to, a silicone topcoat, an acrylic topcoat, or a vinyl varnish topcoat. One example of silicone coatings that provide a hardcoat includes siloxanol resin/colloidal silica dispersions. Siloxanol resin/colloidal silica dispersions are described, for example, in U.S. patent application Ser. No. 13/036,348 and U.S. Pat. No. 8,637,157, the entire disclosures of which are each incorporated herein by reference in its entirety. Examples of suitable silicone coating materials include, but are not limited to, SilFORT™ AS4700, SilFORT™ PHC 587, SilFORT™ AS4000, SilFORT™ SHC2050, SILVUE™ 121, SILVUE™ 339, SILVUE™ MP100, HI-GARD™ 1080, etc.

In one embodiment, the coating system employs a primer disposed between the substrate to be coated and the topcoat or coating layer. The primer may promote adhesion of the coating to the substrate. The primer material is not particularly limited, and may be chosen from any suitable primer material. In one embodiment, the primer is chosen from homo and copolymers of alkyl acrylates, polyurethanes, polycarbonates, urethane hexaacrylates, pentaerythritol triacrylates, polyvinylpyrrolidone, polyvinylbutyrals, poly(ethylene terephthalate), poly(butylene terephthalate), or a combination of two or more thereof. In one embodiment, the primer may be polymethylmethacrylate.

The luminophoric material can be added to the coating composition, the primer material, or both the coating and the primer material. In one embodiment, the coating is provided as a primerless system, and the luminophoric material is incorporated directly into the coating material. In one embodiment, the coating system comprises a primer coating layer and a topcoat coating layer, and the luminophoric material is provided as a component in the primer layer, the topcoat layer, or both the primer and the topcoat layer. In one embodiment, the luminophoric material is a pyridine-based metal complex, and the luminophoric material is added to the primer material.

The luminophoric material can be added to the coating composition or primer material directly or can be dissolved in a solvent or other suitable carrier. In one embodiment, where the luminophoric material is a pyridine-based complex, the complex can be formed by providing the pyridine-based compound, dissolving the compound in a solvent, and then adding a metal material or suitable metal salt to form the complex. The solvent may be a polar and/or non-polar solvent such as methanol, ethanol, n-butanol, t-butanol, n-octanol, n-decanol, 1-methoxy-2-propanol, isopropyl alcohol, ethylene glycol, hexane, decane, isooctane, benzene, toluene, the xylenes, tetrahydrofuran, dioxane, diethyl ether, dibutyl ether, bis(2-methoxyethyl)ether, 1,2-dimethoxyethane, acetonitrile, benzonitrile, aniline, phenylenediamine, phenylenediamine, chloroform, acetone, methylethyl ketone, dimethylformamide (DMF), dimethyl sulfoxide (DMSO), N-methylpyrrolidinone (NMP), and propylene carbonate. Then a metal ion or metal salt may be added into the solution comprising of solvent and ligand. The metal ion or salt may be any appropriate metal ion or salt as discussed above. The metal ion or salt may react with the ligand to form a metal complex in the solvent to form a complex solution. In one embodiment, the luminophoric material may be added to the solvent in an amount ranging from 0.1 wt. % to about 1.0 wt. %; from about 0.2 wt. % to about 0.8 wt. %; even from about 0.3 to about 0.6 wt. %. This composition can then be added to the primer and/or coating composition as desired.

The luminophoric material can be added to the primer and/or coating on any concentration as desired for a particular purpose or intended application. Generally, the luminophoric material should be added in an amount that will not affect or impair the physical properties of the coating including, for example, the optical properties of the coating system. In one embodiment, the luminophoric material is provided in an amount of from about 0.05 wt. % to about 5 wt. %, from about 0.1 wt. % to about 2.5 wt. %, even from about 0.1 wt. % to about 1 wt. % based on the dry weight of the film after curing of the coating.

The coating compositions may include other materials or additives to provide the coating with desired properties for a particular purpose or intended application. For example, the coating composition can comprise a catalyst to reduce the cure time of the coating, surfactants, antioxidants, etc.

The cure catalyst is not particularly limited and any suitable catalyst for curing the coating composition can be used. In one embodiment, the catalyst is a thermal cure catalyst tetrabutylammonium carboxylate of the formula: [(C₄H₉)₄N]⁺[OC(O)—R]⁻, wherein R is selected from the group consisting of hydrogen, alkyl groups containing about 1 to about 8 carbon atoms, and aromatic groups containing about 6 to 20 carbon atoms. In embodiments, R is a group containing about 1 to 4 carbon atoms, such as methyl, ethyl, propyl, butyl, and isobutyl. Exemplary catalysts are tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate. Particularly suitable catalysts are tetra-n-butylammonium acetate and tetra-n-butylammonium formate.

The composition of the invention can also include surfactants as leveling agents. Examples of suitable surfactants include, but are not limited to, fluorinated surfactants such as FLUORAD™ from 3M Company of St. Paul, Minn., and silicone polyethers under the designation Silwet® and CoatOSil® available from Momentive Performance Materials, Inc. of Albany, N.Y. and BYK available from BYK Chemie USA of Wallingford, Conn.

The composition can also include UV absorbers. The UV absorbers can be chosen from organic UV absorbers, inorganic UV absorbers, or a combination thereof. Examples of suitable organic UV absorbers, include but are not limited to, those capable of co-condensing with silanes. Such UV absorbers are disclosed in U.S. Pat. Nos. 4,863,520, 4,374,674, 4,680,232, and 5,391,795 which are herein each incorporated by reference in its entirety. Specific examples include 4-[gamma-(trimethoxysilyl) propoxyl]-2-hydroxy benzophenone and 4-[gamma-(triethoxysilyl) propoxyl]-2-hydroxy benzophenone and 4,6-dibenzoyl-2-(3-triethoxysilylpropyl) resorcinol. When the preferred UV absorbers that are capable of co-condensing with silanes are used, it is important that the UV absorber co-condenses with other reacting species by thoroughly mixing the coating composition before applying it to a substrate. Co-condensing the UV absorber prevents coating performance loss caused by the leaching of free UV absorbers to the environment during weathering.

Examples of suitable inorganic UV absorbers include metal oxide such as, but not limited to, cerium oxide, titanium oxide, zinc oxide, zirconium oxide, or combinations of two or more thereof.

The composition can also include antioxidants such as hindered phenols (e.g. IRGANOX® 1010 from Ciba Specialty Chemicals), dyes (e.g. methylene green, methylene blue and the like), fillers and other additives.

The coating can be applied to any suitable substrate including, but not limited to, organic polymeric materials such as acrylic polymers, e.g., poly(methylmethacrylate), polyamides, polyimides, acrylonitrile-styrene copolymer, styrene-acrylonitrile-butadiene terpolymers, polyvinyl chloride, polyethylene, polycarbonates, copolycarbonates, high-heat polycarbonates, and any other suitable material.

The primer may be coated on a substrate by flow coat, dip coat, spin coat or any other methods known to a person skilled in the field, it is allowed to dry by removal of any solvents, for example by evaporation, thereby leaving a dry coating. The primer may subsequently be cured. Additionally, a topcoat (e.g., a hardcoat layer) may be applied on top of the dried primer layer by flow coat, dip coat, spin coat or any other methods known to a person skilled in the field. Optionally, a topcoat layer may be directly applied to the substrate without a primer layer.

The following examples illustrate embodiments of materials in accordance with the disclosed technology. The examples are intended to illustrate aspects and embodiments of the disclosed technology, and are not intended to limit the claims or disclosure to such specific embodiments.

### EXAMPLES

### Example 1: Synthesis of Alcohol Functionalized Terpyridine

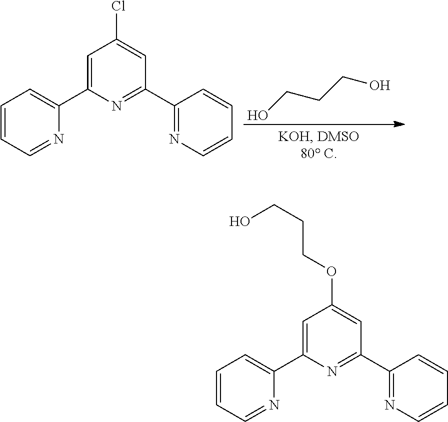

4-Chloro-2,2′:6′,2″-terpyridine (1.5 grams, 5.62 mmol) was taken along with 1,3 propanediol (4.89 grams, 61.82 mmol) and powdered potassium hydroxide (0.63 grams, 11.24 mmol) in dry dimethylsulfoxide (15 ml), heated to 70° C., and kept at that temperature for 24 hours. After 24 hours, the reaction mixture was poured into water. The solid obtained was filtered and dried. NMR confirmed product formation along with the presence of 4-Chloro-2,2′:6′,2″-terpyridine.

### Example 2: Synthesis of Amino Functionalized Terpyridine

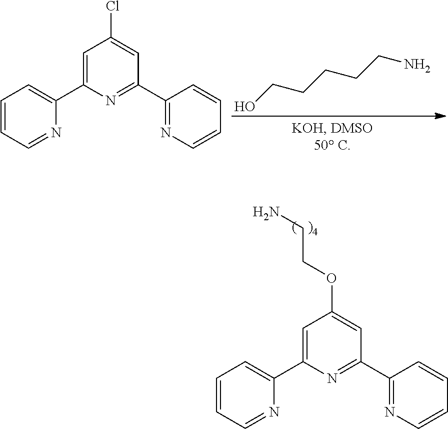

5-amino-1-pentanol (1.96 g, 19.0 mmol) was taken along with potassium hydroxide (0.61 g, 10.89 mmol) and stirred at 50° C. for 30 minutes in dry dimethylsulfoxide. To this, 4-Chloro-2,2′:6′,2″-terpyridine (1.0 g, 3.74 mmol) was added, and the reaction was conducted at 50° C. for 18 hours. After 18 hours, the reaction mixture was poured into ice cold water leading to the formation of a precipitate that was filtered and washed with water and dried. NMR confirmed the product formation.

### Example 3: Synthesis of Trimethoxy Functionalized Terpyridine

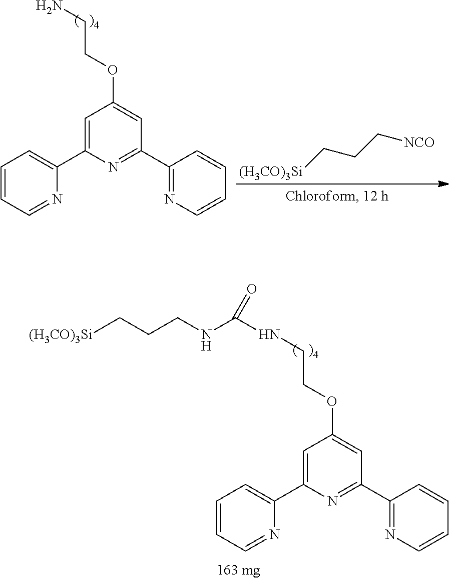

163 mg (0.487 mmol) of Amino functionalized terpyridine from Example 2 was taken along with 3-(Trimethoxysilyl)propyl isocyanate (100 mg, 0.487 mmol) in chloroform (10 ml) and stirred at room temperature for 12 hours. After 12 hours of stirring, the solvent was removed and 1H NMR confirmed product formation.

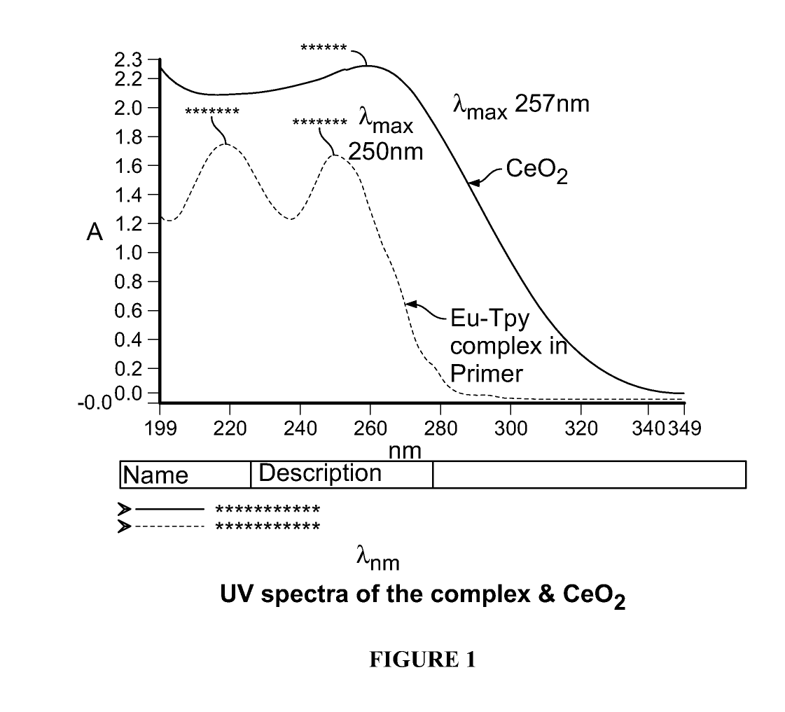

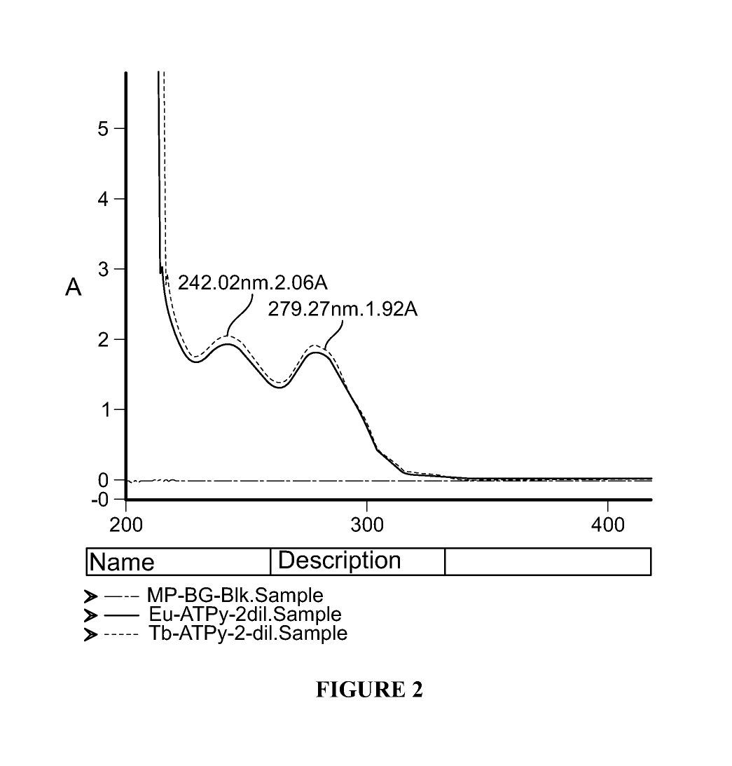

FIG. 1 shows a graph comparing the UV spectra of the Eu-Tpy complex with the terpyridine ligand of Example 1 in primer versus Ceria (CeO₂). The maximum wavelength of the Eu-Tpy complex in primer is 250 nm versus a maximum wavelength of the Ceria of 257 nm. FIG. 2 shows a graph comparing the UV spectra of an Eu-Tpy complex with the terpyridine ligand of Example 1 versus a Tb-Tpy complex with the terpyridine ligand of Example 1. Both complexes show similar absorbance at 242.02 nm and 279.27 nm.

### Example 5: Preparation of Primer Formulations Containing Formula (I) Complexed with Europium

The terpyridine compound of Example 1 was complexed with Europium by dissolving the terpyridine compound (5 mg) in 1-methoxy-2-propanol (1 gram) and adding Eu(III)NO₃.5H₂O (2-3 mg) to form the Eu(III) complex. Then, PMMA solution (10 grams) was added to the prepared complex solution. The resulting primer solution was then flow coated on to the polycarbonate plate and then coated with silicone topcoat formulations (SilFORT™ AS4700 from Momentive Performance Materials).

### Example 6: Preparation of Primer Formulations Containing Formula (II) Complexed with Europium

The terpyridine compound of Example 2 was complexed with Europium by dissolving the terpyridine compound (5 mg) in 1-methoxy-2-propanol (1 gram) and adding Eu(III)NO₃.5H₂O (2-3 mg) to form the Eu(III) complex. Then, PMMA solution (10 grams) was added to the prepared complex solution. The resulting primer solution was then flow coated on to the polycarbonate plate and then coated with silicone topcoat formulations (SilFORT™ AS4700 from Momentive Performance Materials).

### Example 7: Preparation of Primer Formulations Containing Coumarin 6

A prepared complex solution was prepared by dissolving coumarin 6 (5 mg) in 1-methoxy-2-propanol (1 gram). Then, PMMA solution (10 grams) was added to the prepared complex solution. The resulting primer solution was then flow coated on to the polycarbonate plate and then coated with silicone topcoat formulations (SilFORT™ AS4700 from Momentive Performance Materials).

### Example 8: Comparison of Coating and Adhesion Properties

Coated polycarbonate sheet samples were tested for coating and adhesion properties. In one test, the coated polycarbonate sheets were cross-hatch adhesion tested. Long term adhesion was tested by suspending the panels in 65° C. water and testing the adhesion at different intervals.

Additionally, the optical properties (i.e., % transmission and haze) of the samples were measured using a BYK Hazegard instrument. The coated polycarbonate sheets were exposed to long UV radiation (300-400 nm) and the phosphorescence was determined upon illuminating with UV light at 254 nm. The results of all tests are shown in Table 1 below:

TABLE 1

| Entry | Sample | % T | Haze | Initial Adhesion |
|---|---|---|---|---|
| 1 | Eu Complex of | 89.08 | 0.74 | 5B |
| | the ligand of | | | |
| | Example 1 in | | | |
| | PMMA | | | |
| 2 | Tb complex of | 89.4 | 0.55 | 5B |
| | the ligand of | | | |
| | Example 3 in | | | |
| | PMMA | | | |
| 3 | Coumarin 6 in | 87.6 | 2.52 | 5B |
| | PMMA | | | |
| 4 | Coumarin 6 in | 87.7 | 4.22 | 5B |
| | PHC 587 | | | |
| 5 | Coumarin 6 in | 87.8 | 1.45 | 5B |
| | SHP470 | | | |

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

1. A coating composition comprising a luminophoric material.

2. The coating composition of claim 1, wherein the luminophoric material is a pyridine-containing ligand.

3. The coating composition of claim 2, wherein the pyridine-containing ligand is chosen from a substituted or unsubstituted bidentate pyridine compound, a substituted or unsubstituted tridentate pyridine compound, or a combination of two or more thereof.

4. The coating composition of claim 2, wherein the pyridine-containing ligand is a terpyridine compound of the formula: 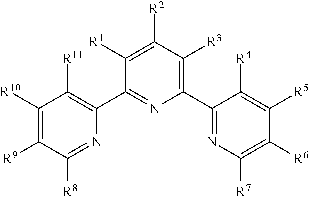
where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

5. The coating composition of claim 4, wherein the terpyridine is derived from a compound of the formula:

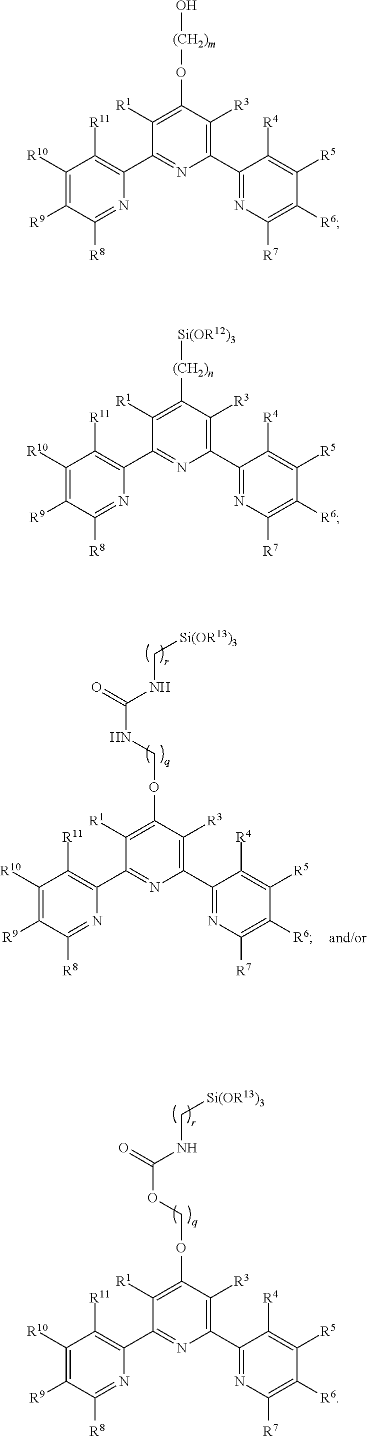

6. The coating composition of claim 2, wherein the terpyridine is complexed with a metal or metal salt.

7. The coating composition of claim 6, wherein the metal or metal salt comprises a metal chosen from europium, erbium, cerium, neodymium, samarium, terbium, dysprosium, gadolinium, holmium, thulium, ytterbium, lutetium, or a combination of two or more thereof.

8. The coating composition of claim 7, wherein the metal salt comprises europium nitrate.

9. The coating composition of claim 1, wherein the luminophoric material is a fluorescent dye selected from: coumarin 460 (blue), coumarin 6 (green), benzocoumarin, nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; benzoxanthene dyes; naphthalimide dyes; lactone dyes; fluorophores such as anti-stokes shift dyes; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-29-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; fluorescein and its derivatives; phenoxazines, benzophenoxazines, napthalimides; or a combination of two or more thereof.

10. The coating composition of claim 1, wherein the luminophoric material is present in an amount of from about 0.05 wt. % to about 5 wt. % based on the dry weight of a film after curing the composition.

11. A coating system comprising a topcoat material and a primer material, wherein at least one of the topcoat material or primer material comprises the composition of claim 1.

12. The coating system of claim 11, wherein the topcoat material comprises the luminophoric material.

13. The coating system of claim 11, wherein the primer material comprises the luminophoric material.

14. The coating system of claim 11, wherein both the topcoat material and the primer material comprise the luminophoric material.

15. An article comprising a coating disposed on at least a portion of a surface of the article, the coating comprising a luminophoric material.

16. The article of claim 15, wherein the luminophoric material is a pyridine-containing ligand.

17. The article of claim 16, wherein the pyridine-containing ligand is chosen from a substituted or unsubstituted bidentate pyridine compound, a substituted or unsubstituted tridentate pyridine compound, or a combination of two or more thereof.

18. The article of claim 15, wherein the pyridine-containing ligand is a terpyridine compound of the formula: 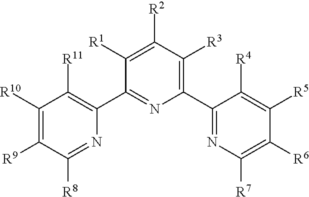
where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

19. The article of claim 18, wherein the terpyridine is chosen from a compound of the formula:

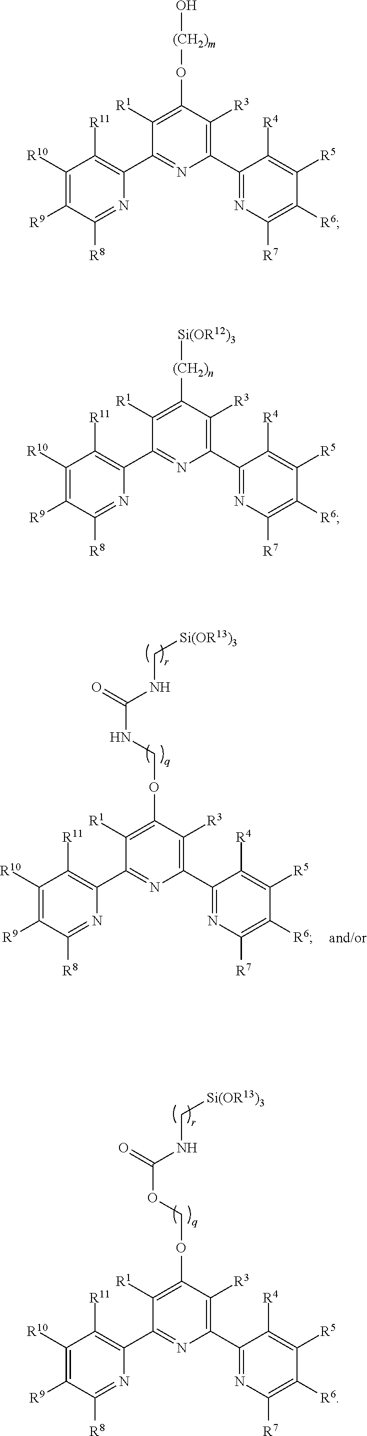

20. The article of claim 16, wherein the terpyridine is complexed with a metal or metal salt.

21. The article of claim 20, wherein the metal or metal salt comprises a metal chosen from europium, erbium, cerium, neodymium, samarium, terbium, dysprosium, gadolinium, holmium, thulium, ytterbium, lutetium, or a combination of two or more thereof.

22. The article of claim 21, wherein the metal salt comprises europium nitrate.

23. The article of claim 15, wherein the luminophoric material is a fluorescent dye selected from: coumarin 460 (blue), coumarin 6 (green), benzocoumarin, nile red or the like; hydrocarbon and substituted hydrocarbon dyes; polycyclic aromatic hydrocarbon dyes; scintillation dyes such as oxazole or oxadiazole dyes; aryl- or heteroaryl-substituted poly (C2-8) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; benzoxanthene dyes; naphthalimide dyes; lactone dyes; fluorophores such as anti-stokes shift dyes; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-29-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; fluorescein and its derivatives; phenoxazines, benzophenoxazines, napthalimides; or a combination of two or more thereof.

24. The article of claim 15, wherein the coating system comprises a topcoat, a primer, or a combination thereof.

25. The article of claim 24, wherein the topcoat material comprises the luminophoric material.

26. The article of claim 24, wherein the primer material comprises the luminophoric material.

27. The article of claim 24, wherein both the topcoat material and the primer material comprise the luminophoric material.

28. The article of claim 15, wherein the coating system is coated on at least a portion of a surface of the article.

29. The article of claim 15, wherein the luminophoric material is present in an amount of from about 0.05 wt. % to about 5 wt. % based on the dry weight of a film after curing the composition.

30. The article of claim 15, wherein the article comprises a substrate material chosen from chosen from an acrylic polymer, a polyamide, a polyimide, an acrylonitrile-styrene copolymer, a polyvinyl chloride, a polycarbonate, a copolycarbonate, or a combination of two or more thereof.

31. A method of making a coating composition comprising adding a metal complex to a topcoat composition, a primer material, or both, wherein the metal complex is a terpyridine compound of the formula: 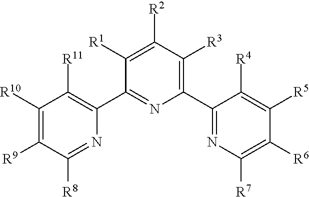
where R¹-R¹¹ are independently chosen from an alkyl, a substituted alkyl, an aryl, a substituted aryl, an inert functional group, an alkoxysilyl functional group, and an alcohol functional group, optionally any two of R¹-R¹¹ vicinal to one another, R¹/R¹¹ and/or R³/R⁴ taken together may form a ring being a substituted or unsubstituted, saturated, or unsaturated cyclic structure, with the proviso that the compound comprises an alkoxysilyl functional group, an alcohol functional group, or a combination of two or more thereof.

32. The method of claim 31, wherein the terpyridine is chosen from a compound of the formula:

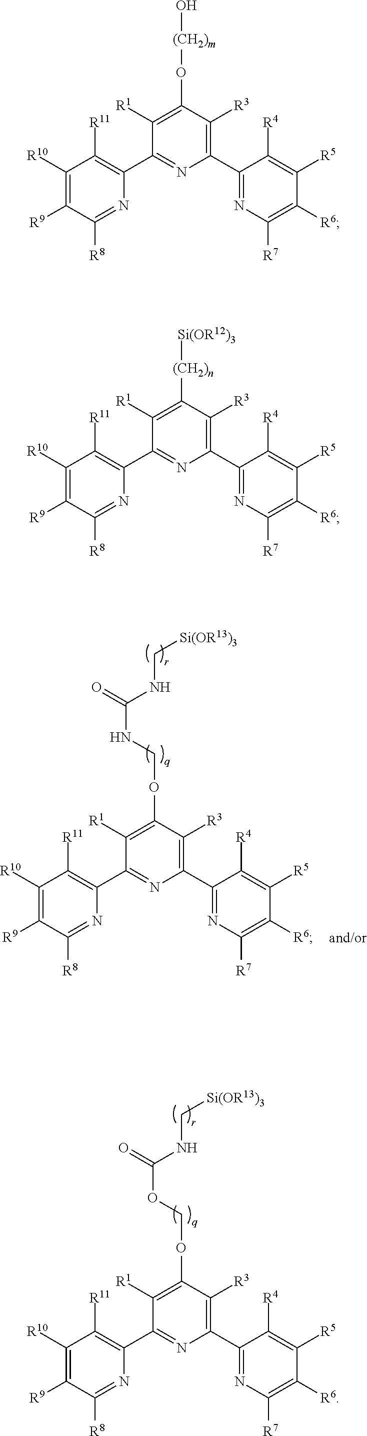

33. The method of claim 31, wherein the terpyridine is complexed with a metal or metal salt.

34. The method of claim 33, wherein the metal or metal salt comprises a metal chosen from europium, erbium, cerium, neodymium, samarium, terbium, dysprosium, gadolinium, holmium, thulium, ytterbium, lutetium, or a combination of two or more thereof.
